(19) United States
(12) Patent Application Publication
(10) Pub. No.: US 2002/0126133 A1
(43) Pub. Date: Sep. 12, 2002

(54) Fast anisotropic/anisotropy sensitive single MIPmap sampled filtering

(75) Inventor: Jon P. Ewins, Ashford (GB)

Correspondence Address: Groover & Associates p.c., Suite 230, 17000 Preston Road, Dallas, TX, 75248, US

(73) Assignee: 3Dlabs Inc., Ltd.

(21) Appl. No.: 10/071,896

(22) Filed: Feb. 8, 2002

Related U.S. Application Data
(60) Provisional application No. 60/267,266, filed on Feb. 8, 2001.

(51) Int. Cl. G09G 5/00

(52) U.S. Cl. 345/587

(57) ABSTRACT

A trilinear MIPmap filtering technique wherein the LOD bias is derived from both major axis and minor axis minification.

### CROSS-REFERENCE TO OTHER APPLICATION

This application claims priority from provisional application No. 60/267,266 filed Feb. 8, 2001, which is hereby incorporated by reference.

### BACKGROUND AND SUMMARY OF THE INVENTION

The present invention relates to texture mapping in 3D graphics, and particularly to texture filtering.

Background: 3D Computer Graphics

One of the driving features in the performance of most single-user computers is computer graphics. This is particularly important in workstations and gaming-oriented consumer models, but is generally important in almost all market segments.

For some years the most critical area of graphics development has been in three-dimensional (“3D”) graphics. The peculiar demands of 3D graphics are driven by the need to present a realistic view, on a computer monitor, of a three-dimensional scene. The pattern written onto the two-dimensional screen must therefore be derived from the three-dimensional geometries in such a way that the user can easily “see” the three-dimensional scene (as if the screen were merely a window into a real three-dimensional scene). This requires extensive computation to obtain the correct image for display, taking account of surface textures, lighting, shadowing, and other characteristics.

Application software will define what happens to the objects in the three-dimensional scene. For example, a program in game-specific source code might determine, at any given moment, what figures and scenery could possibly be visible, and, for each particular figure, what the figure is wearing, what the positions of the figure's arms and legs are, whether the figure is running etc. The game engine software will accordingly generate a set of triangles (in three-dimensional coordinates) which determine the screen view. This set of triangles must be recalculated each time the screen view is refreshed, e.g. 85 times per second. Even after this has been done, an immense amount of computation still has to be done to produce the correct screen view for each refresh. This calculation is the job of the 3D graphics pipeline, and at least some of this pipeline is normally implemented in dedicated hardware.

The visual appeal of computer graphics rendering is greatly enhanced by the use of “textures.” A texture is a two-dimensional image which is mapped into the data to be rendered. Textures provide a very efficient way to generate the minor surface detail which makes synthetic images look realistic, without requiring transfer of immense amounts of data. Texture patterns provide realistic detail at the sub-polygon level, so the higher-level tasks of polygon-processing are not overloaded. Game programmers in particular have found that texture mapping is generally a very efficient way to achieve very dynamic images without requiring a hugely increased memory bandwidth for data handling. Thus the inputs to the 3D graphics pipeline include not only polygons, but also references to texture maps.

Thus the starting point for the 3D graphics pipeline is a set of textured 3D polygons, each having attributes such as color and three-dimensional spatial location (for each vertex), reflectivity, and texture map identification and orientation. (For example, a walking human, at a given instant, might be translated into a few hundred triangles which map out the three-dimensional surface of the human's body.)

The 3D graphics pipeline consists of two major stages, or subsystems, referred to as geometry and rendering. The geometry stage is responsible for managing all polygon activities and for converting three-dimensional spatial data into a two-dimensional representation of the viewed scene, with properly-transformed polygons. The polygons in the three-dimensional scene, with their applied textures, must then be transformed to obtain their correct appearance from the viewpoint of the moment; this transformation requires calculation of lighting (and apparent brightness), foreshortening, obstruction, etc.

However, even after these transformations and extensive calculations have been done, there is still a large amount of data manipulation to be done: the correct values for EACH PIXEL of the transformed polygons must be derived from the two-dimensional representation. (This requires not only interpolation of pixel values within a polygon, but also correct application of properly oriented texture maps.) The rendering stage is responsible for these activities: it “renders” the two-dimensional data received from the geometry stage to produce correct values for all pixels of each frame of the image sequence. The image can then be displayed on a CRT, flat-panel, or virtual reality display device.

FIG. 2 shows a high-level overview of the processes performed in the overall 3D graphics pipeline. However, this is a very general overview, which ignores the crucial issues of what hardware performs which operations.

Background: Texturing

A typical graphics system reads data from a texture map, processes it, and writes color data to display memory. The processing may include mipmap filtering which requires access to several maps. The individual elements of a texture map are called “texels.”

Awkward side-effects of texture mapping occur unless the renderer can apply texture maps with correct perspective. Perspective-corrected texture mapping involves an algorithm that translates “texels” (data points from the bitmap texture image) into display pixels in accordance with the spatial orientation of the surface. Since the surfaces are transformed (by the host or geometry engine) to produce a 2D view, the textures will need to be similarly transformed by a linear transform (normally projective or “affine”).

Background: Texture Filtering

A convenient way to think of a texture map is as a representation of a continuous texture. Thus each individual value (or “texel”) in the stored texture map merely represents a sample of the continuous texture at a particular point, and the whole set of texels collectively merely represents a spatially distributed sampling of the continuous texture.

This conception is useful in analyzing the mapping between a texture map and image space. One pixel in the image space can fall across many texels in the stored texture map, or one texel may cover many pixels. Thus the process of obtaining the correct color value for each pixel (when a texture is applied) can be regarded as a process of adjusting the stored texture sampling to that needed for each pixel. (For this reason it is often useful to think in terms of the inverse mapping, from screen space to texture space, to see what the footprint of a pixel is.) Texture minification is more commonly required than texture magnification, i.e. the more common problem is to quickly reduce the sampling density in the stored texture map to get the data required for the screen. The process of converting the texture sampling density is referred to as “filtering.”

The filtering process is greatly aided by mipmap storage of textures. Mipmapping is a technique to allow the efficient filtering of texture maps when the projected area of the fragment covers more than one texel (i.e. minification). A hierarchy of texture maps (generally two or three, but possibly more) is held, with each one being half the scale (or one quarter the area) of the preceding one. Thus mipmapping can provide a large version of a texture map for use when the object is close to the viewer, and a small version of the texture map for use when the object shrinks from view.

Thus the mipmap data structure itself can be regarded as providing some pre-encoded filtering capability. However, the filtering capability provided by selecting a level-of-detail is far from optimal. The projective transforms which are performed on the textured polygons can include a very high degree of foreshortening. In this case the magnification or minification (in one direction of a 2D texture map) may be several or many times the magnification or minification in the other direction. As discussed below, straightforward use of the level-of-detail parameter does not optimally fit this situation.

For optimal texture mapping under foreshortening, ANISO-TROPIC texture filtering would be desirable. The OpenGL standard has been amended to provide for this capability, but no consensus has yet emerged on how to perform anisotropic texture filtering. The present application describes a new approach to this need.

Texture filtering, like other operations in the 3D graphics pipeline, is a real-time computing operation which must be completed within a fixed time budget. Throughput is important, and absolutely must be kept within a certain maximum delay. Thus any computational shortcuts which can accelerate texture filtering would be very attractive.

Anisotropy-Sensitive Single MIPmap Sampled Filtering

The present application describes methods for trilinear MIPmap filtering wherein the LOD parameter is based on an interpolation (e.g. an average) which is a function of both major-axis and minor-axis minification.

The disclosed innovations, in various embodiments, provide one or more of at least the following advantages:

avoidance of both blurring and aliasing during anisotropic filtering

anisotropically prefiltered maps not required

no extra storage required.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIGS. 1A and 1B schematically show how different LOD values result, when the pre-image of a pixel in texture space has unequal axes, using the present invention (FIG. 1A) as opposed to conventional methods (FIG. 1B).

FIG. 2 is a high-level overview of the processes performed in the overall 3D graphics pipeline.

FIG. 2A shows an example of the footprint in texture space of a single pixel in a 2D-texture mapped polygon.

FIG. 3 is a block diagram of a 3D graphics accelerator subsystem in which the texture filtering function of FIG. 1 can be implemented.

FIG. 4 is a block diagram of a computer which includes the 3D graphics accelerator subsystem of FIG. 3.

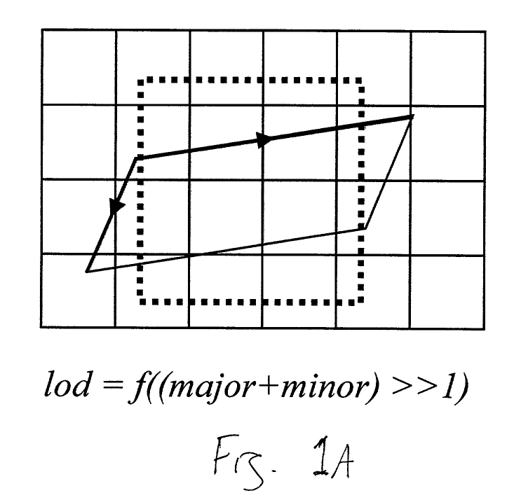

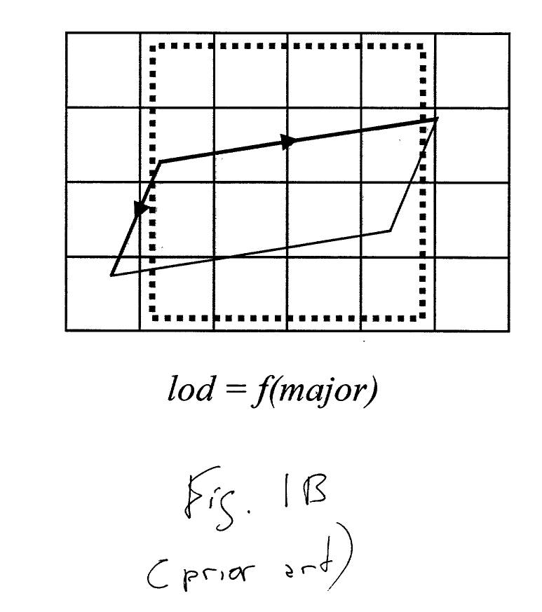

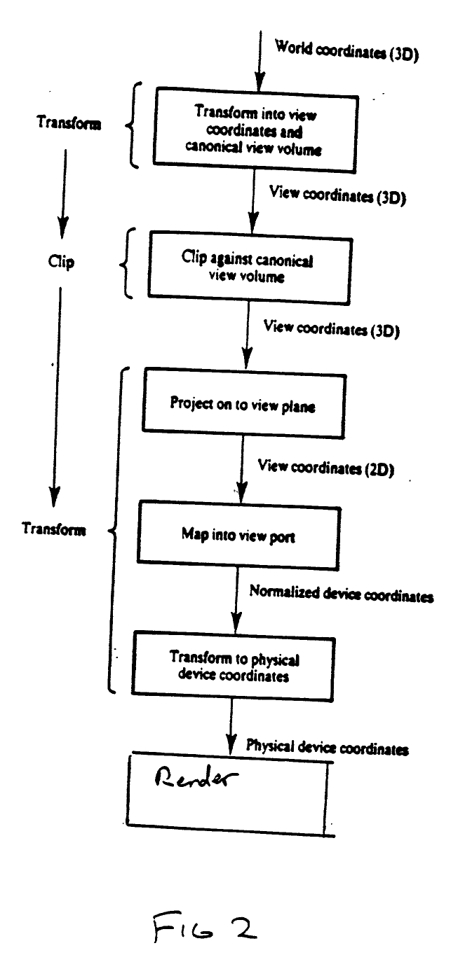

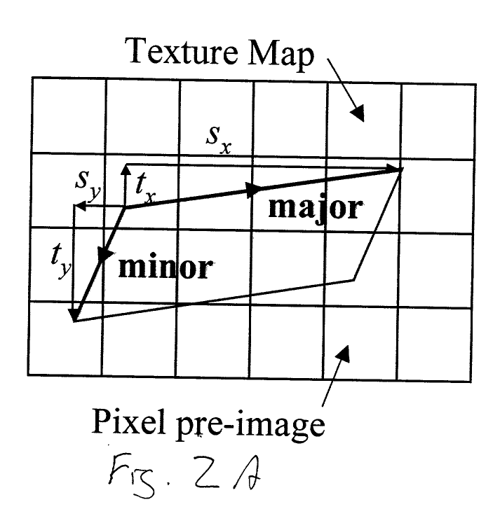

### DETAILED DESCRIPTION OF THE PREFERRED EMBODIMENTS

The numerous innovative teachings of the present application will be described with particular reference to the presently preferred embodiment (by way of example, and not of limitation).

MIPmap based trilinear filtering provides a level of image filtering at a constant performance cost. A disadvantage with many implementations of such filters is that they assume an isotropic filter kernel, while in reality the pre-image of a screen space pixel mapped to texture space will often be non-uniformly compressed or minified along each axis. The fitting of such a uniform isotropic kernel has traditionally been based on the major axis of texture minification, with blurring in the direction of the minor axis accepted in preference to aliasing in the direction of the major axis. However, for textures with significant high spatial detail, such as text, this blurring can be excessive.

One approach to alleviating this artifact is to apply a fixed bias to the calculated MIPmap level of detail (LOD) for such selected textures. Automatically adapting to anisotropic distortion has required either pre-filtering to a range of anisotropic ratios (requiring extra texture storage), or the use of multiple MIPmap trilinear samples (impacting on performance). The new method presented here performs filtering with a single MIPmap trilinear sample, requiring no extra storage beyond that of a traditional MIPmap, by automatically determining, on a per pixel basis, an adaptive LOD bias based on the anisotropic distortion of the pixel pre-image. Also, unlike earlier methods, the LOD bias is applied during the calculation of the texture minification value, prior to extraction of the LOD values of MIPmap level and inter-level interpolant.

The pre-image projection of a screen pixel into texture space can be represented as a parallelogram, as estimated by the partial derivatives sₓ, tₓ, s_{y}, t_{y} of the texture coordinates s and t with respect to x and y. The longer and shorter of these edges can be used to approximate the major and minor axes of texture minification. Traditionally the LOD used for trilinear filtering is extracted from the minification of the major axes. In this method, the LOD is extracted from the minification calculated as the average of that of the major and minor axes.

In general, the process can be divided into the following steps (for 2D texture).

1. Determine the upper and lower bounds of texture minification.

2. Interpolate between these bounds to determine the minification used for LOD extraction.

3. Determine the level of detail and perform filtering in same way as traditional trilinear filtering.

Graphics Accelerator Embodiment

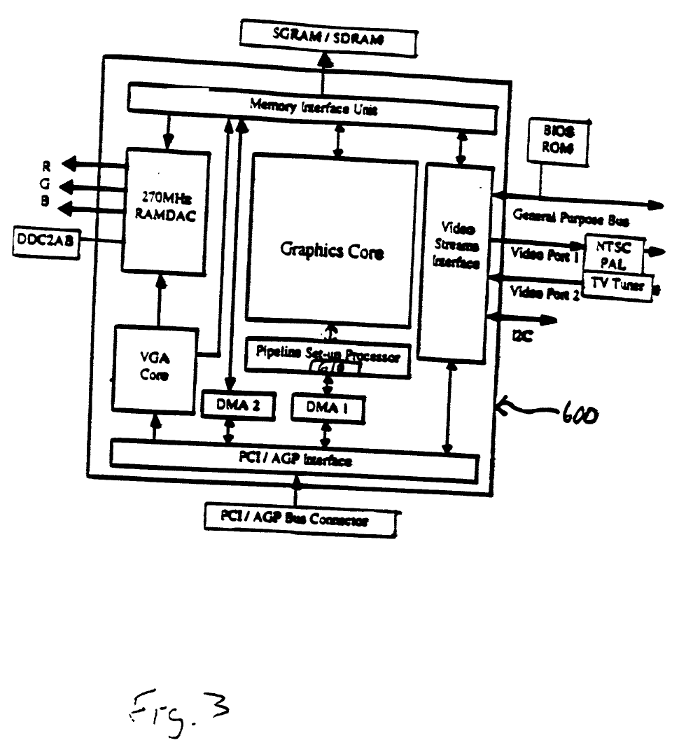

FIG. 3 shows a graphics processor 600 incorporating the disclosed texture filter. A PCI/AGP Interface accepts data from a PCI/AGP Bus Connector. Commands and data destined for Graphics Core pass in through DMA1, and graphics data bound for memory passes in through DMA2.

Computer Embodiment

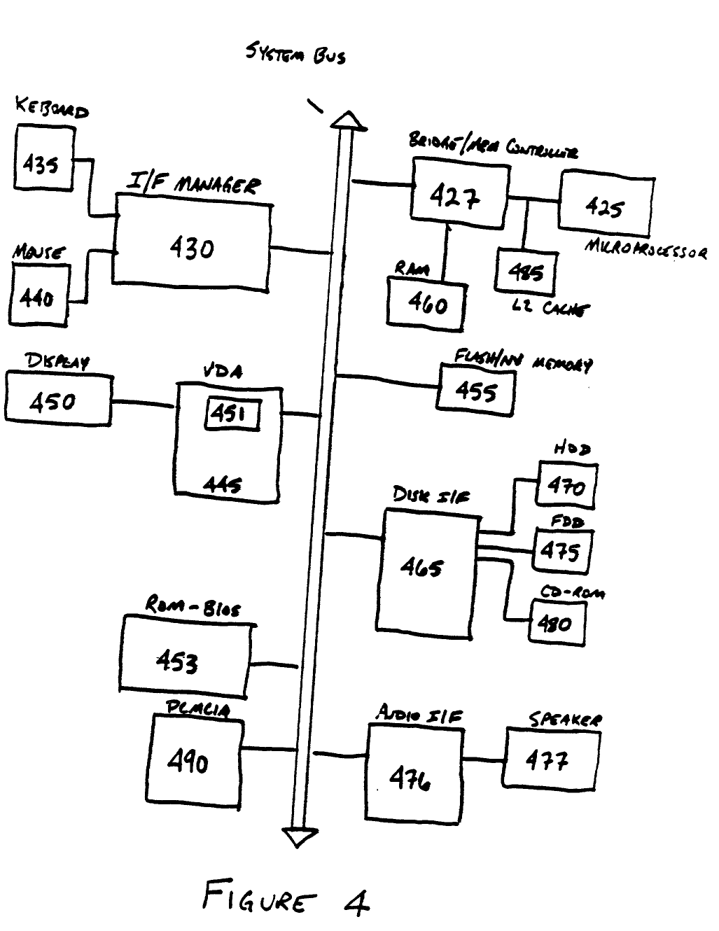

FIG. 4 shows a complete computer system, incorporating the graphics accelerator of FIG. 3, and including in this example: user input devices (e.g. keyboard 435 and mouse 440); at least one microprocessor 425 which is operatively connected to receive inputs from the input devices, across e.g. a system bus 431, through an interface manager chip 430 which provides an interface to the various ports and registers. The microprocessor interfaces to the system bus through e.g. a bridge controller 427. Memory (e.g. flash or non-volatile memory 455, RAM 460, and BIOS 453) is accessible by the microprocessor. a data output device (e.g. display 450 and video display adapter card 445, which includes a graphics accelerator subsystem 451) which is connected to output data generated by the microprocessor 425; and a mass storage disk drive 470 which is read-write accessible, through an interface unit 465, by the microprocessor 425. Optionally, of course, many other components can be included, and this configuration is not definitive by any means. For example, the computer may also include a CD-ROM drive 480 and floppy disk drive (“FDD”) 475 which may interface to the disk interface controller 465. Additionally, L2 cache 485 may be added to speed data access from the disk drives to the microprocessor 425, and a PCMCIA 490 slot accommodates peripheral enhancements. The computer may also accommodate an audio system for multimedia capability comprising a sound card 476 and a speaker(s) 477.

Modifications and Variations

As will be recognized by those skilled in the art, the innovative concepts described in the present application can be modified and varied over a tremendous range of applications, and accordingly the scope of patented subject matter is not limited by any of the specific exemplary teachings given.

In the example provided, the upper and lower bounds of minification were determined from the major and minor axes of a pixel pre-image parallelogram, as described by the partial derivatives of the texture coordinates s and t with respect to x and y. These bounds could also be determined by other means including, without exclusivity, the diagonals of the parallelogram, the axes of a non-uniform quadrilateral pre-image determined from edge midpoint intersections, or the axes of an elliptical pre-image.

Similarly, the interpolation function used to determine the minification value to be used from these upper and lower bounds need not be limited to the average method given in the example. The trade off between aliasing and blurring can be controlled by this function. Likewise, a cap can be set on the maximum permitted LOD bias that can take place. As the anisotropic distortion increases, the reduction in LOD could lead to excessive aliasing. Generally, such high ratios occur towards vanishing points where increased blurring is acceptable.

Also the technique is extensible beyond 2D textures. For 3D texturing using 2D slice accumulation, the technique is clearly valid for each slice.

Alternatively, the approach could be extended beyond two minification bounds and the interpolation function adapted accordingly.

Additional general bacWkground, which helps to show variations and implementations, may be found in the following publications, all of which are hereby incorporated by reference: Advances in Computer Graphics (ed. Enderle 1990); Angel, Interactive Computer Graphics: A Top-Down Approach with OpenGL; Angell, High-Resolution Computer Graphics Using C (1990); the several books of “Jim Blinn's Corner” coiumns; Computer Graphics Hardware (ed. Reghbati and Lee 1988); Computer Graphics: Image Synthesis (ed. Joy et al.); Eberly: 3D Game Engine Design (2000); Ebert: Texturing and Modelling 2.ed. (1998); Foley et al., Fundamentals of Interactive Computer Graphics (2.ed. 1984); Foley, Computer Graphics Principles & Practice (2.ed. 1990); Foley, Introduction to Computer Graphics (1994); Glidden: Graphics Programming With Direct3D (1997); Hearn and Baker, Computer Graphics (2.ed. 1994); Hill: Computer Graphics Using OpenGL; Latham, Dictionary of Computer Graphics (1991); Tomas Moeller and Eric Haines, Real-Time Rendering (1999); Michael O'Rourke, Principles of Three-Dimensional Computer Animation; Prosise, How Computer Graphics Work (1994); Rimmer, Bit Mapped Graphics (2.ed. 1993); Rogers et al., Mathematical Elements for Computer Graphics (2.ed. 1990); Rogers, Procedural Elements For Computer Graphics (1997); Salmon, Computer Graphics Systems & Concepts (1987); Schachter, Computer Image Generation (1990); Watt, Three-Dimensional Computer Graphics (2.ed. 1994, 3.ed. 2000); Watt and Watt, Advanced Animation and Rendering Techniques: Theory and Practice; Scott Whitman, Multiprocessor Methods For Computer Graphics Rendering; the SIGGRAPH Proceedings for the years 1980 to date; and the IEEE Computer Graphics and Applications magazine for the years 1990 to date. These publications (all of which are hereby incorporated by reference) also illustrate the knowledge of those skilled in the art regarding possible modifications and variations of the disclosed concepts and embodiments, and regarding the predictable results of such modifications.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

What is claimed is:

1. A method of anisotropic single-pass MIPmap texture filtering, comprising the actions of:
determining an upper and a lower bound of texture minification for a desired projective transform;
interpolating between said upper and lower bounds to determine an intermediate minification value;
using said intermediate minification value to define a level-of-detail value; and
performing MIPmap filtering in accordance with said level-of-detail value.

2. The method of claim 1, wherein said step of interpolating is a simple averaging step.

3. The method of claim 1, wherein said interpolating step averages said upper and lower bounds.
